(19) United States
(12) Patent Application Publication
(10) Pub. No.: US 2026/0344884 A1
(43) Pub. Date: Nov. 5, 2026

(54) SHEET METAL FITTING FOR MOUNTING IN A BEAM STRUCTURE COMPRISING FLAT ARMS EXTENDING MUTUALLY PERPENDICULARLY IN A SINGLE PLANE

(71) Applicant: ELFA INTERNATIONAL AB, VÄSTERVIK (SE)

(72) Inventors: Peter NILSSON, VÄSTERVIK (SE); Ludvig RIGNELL, VÄSTERVIK (SE)

(21) Appl. No.: 19/488,012

(22) PCT Filed: May 21, 2024
(86) PCT No.: PCT/SE2024/050490

§ 371 Date: Nov. 25, 2025

(30) Foreign Application Priority Data
May 26, 2023 (SE) 2350647-0

(51) Int. Cl. A47B 47/02; F16B 12/50

(52) U.S. Cl. CPC A47B 47/02; F16B 12/50; A47B 2220/0083; A47B 2230/01

(57) ABSTRACT

A fitting, for mounting in a beam structure, comprises a first and a second flat arm, which are arranged to extend mutually perpendicularly in a single plane. A cabinet structure comprises a top panel (6), a bottom panel (7), and two side panels (8), of a sheet metal. Each of the panels (6, 7, 8) comprises at least one beam structure at an edge area of the panel (6, 7, 8). The beam structure is formed by at least one bend in the sheet metal along an edge of the panel (6, 7, 8). A cabinet (1) comprises the cabinet structure, a back panel (9), and a door (2). A method for assembling the cabinet structure with at least one fitting, comprises the steps of inserting the fitting into at least two beam structures, aligning bores in the fitting with bores in the beam structures, and securing the beam structures and the fitting with a screw through the bores.

### FIELD OF THE INVENTION

The present invention relates to a fitting for mounting in a beam structure, the fitting comprising a sheet metal material.

The invention also relates to a cabinet structure comprising a top panel, a bottom panel, and two side panels, the panels comprising sheet metal.

Further, the invention relates to a cabinet comprising the cabinet structure, a back panel, and a door.

Finally, the invention relates to a method for assembling the cabinet structure.

### BACKGROUND

In workplaces, such as a workshop, a garage, a vehicle of a qualified tradesman, etc, there is a need for storage of various equipment, such as tools, manuals, fastening elements etc. The environment wherein it is placed may be harsh and call for a durable construction, since exposure to impacts, heat, cold could be frequent.

Since valuable objects may be stored in the cabinet, it is preferably lockable, to obstruct thefts or unauthorized access. The cabinet does not need to classify as a safe nor as an airtight or fireproof cabinet. The interior of the cabinet may be customized to the wishes of the user. Shelves, drawers, hooks, etc. may be needed. For some uses, there is a need for an easily movable cabinet, to various workplaces or onto a vehicle for temporary use on a building site, etc.

Cabinets like this are sold via various sales channels, such as online stores, DIY stores, hardware stores. Professionals as well as private consumers are prospective buyers. There is a general desire to keep the costs for the cabinets as low as possible, in order for the product to be compatible on the market. By selling the cabinets in flat parcels, to be assembled by the end consumer, space, and thereby costs, may be saved during transport and storage. A space-efficient handling of the cabinets is also desirable from an environmental point of view.

The assembly of the cabinet must be quick and easy to perform, and the finished cabinet must be robust and durable, otherwise the product will not be desirable.

### SUMMARY

It is an object of the present invention to solve, or at least mitigate, parts or all of the above mentioned problems. To this end, there is provided a fitting, which further comprises a first and a second flat arm, arranged to extend mutually perpendicularly in a single plane.

Hereby the fitting may serve as a connection element between two beam structures arranged at an angle to one another, typically at a right angle. The resulting connection is stable and durable.

In an embodiment of the fitting, the first and second arms each has outer limitation lines, and a corner section of the fitting is defined by extensions of all the limitation lines, and a bore is arranged in the corner section.

Hereby a single screw may be applied through the bore and through bores in the beam structures to be connected. Since the bore is located in a central position, the pulling force from the tightened screw may be transferred to a comparable degree along the two directions of the arms, and the connected beam structures may be kept in position.

In some embodiments a third flat arm is arranged to extend perpendicularly to the plane of the first and second arms.

In some cases, the third arm may have a supporting function outside of the plane of the first and second arm. Also beam structures extending outside of that plane may also be joined to the beam structures that are connected by the first and second arms.

In a further embodiment, a bore is arranged in the third flat arm.

Hereby the beam structures to be connected may be joined with a screw in an inconspicuous position, e. g. inserted from the bottom of a construction.

In a second aspect of the disclosure, each of the panels of the cabinet structure comprises at least one beam structure at an edge area of the panel, the beam structure being formed by at least one bend in the sheet metal along an edge of the panel.

Hereby the beam structures form an integral part of the panels, and they need not be fixed to the panels by any time-consuming process, such as riveting, welding etc. The beam structures as such make the panels stable as a whole, in particular at their edge areas. The beam structures may preferably be utilized for a durable and inconspicuous joining of the panels into the cabinet structure.

In an embodiment of the cabinet structure, the beam structure is formed by two parallel bends along the edge of the panel.

Hereby the beam structures may be formed as hollow, C-shaped beams, which are still integral parts of the respective panels. They will be resistant to bending. Also, they will comprise several surfaces, which may be utilized for the joining of two or more panels to one another, in particularly inconspicuous joints.

In some embodiments, at least two beam structures are joined at right angles.

Hereby strong and durable corners for a cabinet may be formed. A construction including the cabinet structure may be useful in harsh environments, such as workshops, garages, vehicles, etc.

In a further embodiment, the beam structures include cut-outs allowing a partial overlap at a joint between them.

Hereby the beam structures may be joined with a continuous space at their interior, such that a fitting extending into more than one beam structure may be placed at the joint on the inside of the beam structures. Hereby a smooth exterior of the cabinet structure may be attained.

In some embodiments a fitting as described above is included.

Hereby the beam structures may be joined efficiently with as few elements as possible, thereby enabling a storage and transport in flat parcels, as well as a quick assembly of the cabinet structure.

In a further embodiment the fitting is positioned to extend into at least two of the beam structures.

Hereby an inconspicuous joining of the beam structures may be performed with as few elements as possible.

In a still further embodiment, the arms of the fitting has a width slightly less than one side of the beam structures.

Hereby the insertion of the fitting into the beam structures to a position in contact with an inner surface of the beam structure. The tightening force from a screw through the fitting may be transferred via the fitting to the inner surfaces of the beam structures, and a stable construction will result.

In a third aspect of the disclosure, the cabinet structure is provided with a back panel, and a door.

Hereby a complete cabinet may be attained, although the cabinet structure as such may also be used in other constructions and furniture, such as boxes, storage shelves, etc.

In an embodiment, the cabinet further comprises a fitting as described above. Hereby a particularly stable cabinet, which is easy to assemble will result. The joints between the parts may require only a small number of components, and the joints may be inconspicuous.

In some embodiments, the door is pivotable on pivots arranged on at least one beam structure.

Hereby the assembly will be easy and require few parts. The exterior of the cabinet will be smooth without protruding parts, such as exterior hinges.

In some embodiments the cabinet comprises castor wheels.

Hereby the cabinet may be easy to move, even when it contains heavy equipment, e. g. from one part to another of a workshop, or onto a vehicle, etc.

In a fourth embodiment of the disclosure, the assembly method comprises the steps of inserting the fitting into at least two beam structures, aligning bores in the fitting with bores in the beam structures, and securing the beam structures and the fitting with a screw through the bores.

Hereby the cabinet may be stored, transported and delivered in a compact, flat package, and assembled on or near the site of use. The assembly requires no highly specialized equipment and may be performed by unskilled personnel.

It is noted that embodiments of the invention may be embodied by all possible combinations of features recited in the claims. Further, it will be appreciated that the various embodiments described for the device are all combinable with the method as defined in accordance with the second aspect of the present invention, and vice versa.

### BRIEF DESCRIPTION OF THE DRAWINGS

The above, as well as additional objects, features and advantages of the present invention, will be better understood through the following illustrative and non-limiting detailed description of preferred embodiments of the present invention, with reference to the appended drawings, where the same reference numerals will be used for similar elements, wherein:

FIG. 1 is a diagrammatic view in perspective of a cabinet according to one embodiment of the disclosure;

FIG. 2 is an exploded, partial view in perspective from below of a bottom corner of the cabinet of FIG. 1;

FIG. 3a is a partial, partially sectional, side view of the bottom corner according to FIG. 2;

FIG. 3b is a partial, partially sectional, front view of the bottom corner according to FIG. 2;

FIG. 4a is a perspective view of a bottom reinforcement angle bar comprised in the cabinet;

FIG. 4b is a plan view of the bottom reinforcement angle bar according to FIG. 4a;

FIG. 5 is an exploded, partial view in perspective from below of a top corner of the cabinet of FIG. 1;

FIG. 6a is a partial, partially sectional, side view of the top corner according to FIG. 5;

FIG. 6b is a partial, partially sectional, front view of the top corner according to FIG. 5; and

FIG. 7 is a perspective view of a top reinforcement angle bar comprised in the cabinet.

All the figures are schematic, not necessarily to scale, and generally only show parts which are necessary in order to elucidate the embodiments, wherein other parts may be omitted.

### DETAILED DESCRIPTION OF THE EXEMPLARY EMBODIMENTS

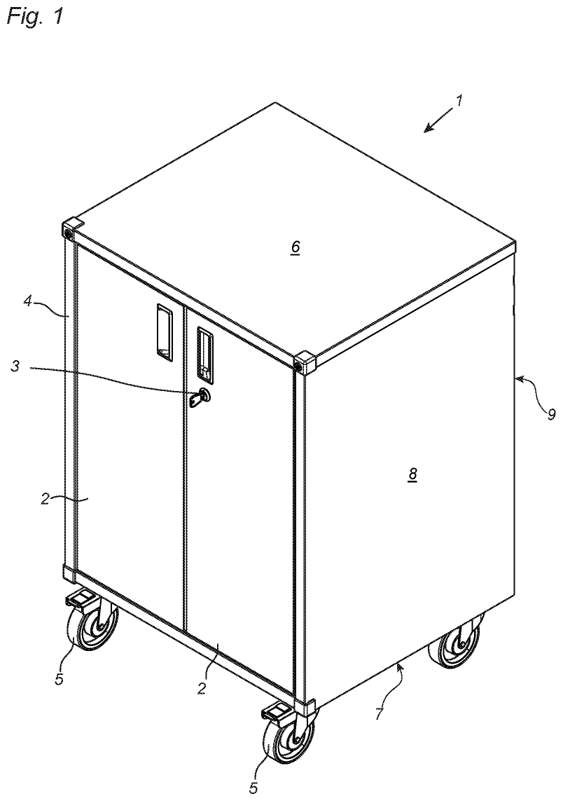

FIG. 1 illustrates a cabinet 1 according to the disclosure. Examples of intended uses for such a cabinet 1 includes storage, i. e. of tools, chemicals, utensils, or other equipment, in a workplace, such as a workshop, a garage, a vehicle of a qualified tradesman, etc. The environment wherein it is placed may call for a durable construction, since exposure to impacts, heat, cold could be frequent. For this reason, the cabinet 1 is preferably manufactured from sheet metal.

The cabinet 1 may have one or more doors 2, for access to its interior. In the disclosed embodiment there are two pivotable doors 2, but other embodiments may be envisioned, wherein there is only one pivotable door, or a rollable shutter, etc.

Since valuable objects may be stored therein, the cabinet 1 is preferably lockable, in order to obstruct thefts or unauthorized access to the objects in the cabinet. In FIG. 1, a lock 3 is seen. Such a lock 3 may be configured to lock the doors 2 to one another or to a part of the frame 4 around the doors 2. However, the cabinet 1 does not necessarily classify as a safe or an airtight or fireproof cabinet.

The interior of the cabinet 1 is variable in order to allow for a customization to the wishes of the user. Shelves, drawers, hooks, or other fittings may be installed as needed.

The cabinet 1 is provided with castor wheels 5 in the embodiment disclosed in FIG. 1. Hereby the cabinet 1 may be easily movable, regardless of its weight, as needed for use in different parts of a workshop. Also, the cabinet 1 may be easily transported, onto a vehicle for temporary use on a building site or wherever work has to be performed with the equipment stored in the cabinet 1. At least two of the castor wheels 5 are lockable, such that the cabinet 1 may remain in its place for serving as a temporary workbench or during transportation on a vehicle.

The cabinet 1 may be sold via various sales channels, such as online stores, DIY stores, hardware stores. The intended users may be professionals as well as private consumers. In most cases the cost for transport and storage of the cabinets 1 before they reach the end customer needs to be kept as low as possible, in order for the product to be compatible on the market. By selling the cabinets 1 in flat parcels, to be assembled by the end consumer, space, and thereby costs, may be saved during transport and storage. Such a cost-efficient handling of the cabinets 1 is also desirable from an environmental point of view.

The parts included in the cabinet 1 are approximately shaped as flat rectangles, i. e. the top panel 6, the bottom panel 7, the lateral panels 8, the back panel 9 and the doors 2. In order to make the assembly quick and easy to perform, and to make the finished cabinet 1 robust and durable, the edge areas of the panels 6, 7, 8, 9 forming the cabinet box are, however, provided with a series of bendings.

The bendings form integrated beam structures 10a, 10b, 10c, which serve as support for the interconnection of the panels 6, 7, 8, 9, and for the attachment of the castor wheels 5, or of similar support devices. The assembly of the cabinet 1 requires no complex operations, such as cutting, punching, or welding, but merely screwing attachment of the components through preformed holes therein. Such an assembly requires no special skills or equipment, other than the use of regular hand tools, such as a screwdriver.

The beam structures 10a, 10b, 10c of the sheet metal along the edges of the panels 6, 7, 8, 9 also form the front frame 4, which not only serve for attachment of the castor wheels 5, etc., but also for pivotal attachment of the doors 2. Also, in some embodiments comprising a single door 2, the lock 3 may interact with a part of the frame 4, and this part of the frame may serve as an integrated strike plate. The frame 4 needs structural stability also for these purposes.

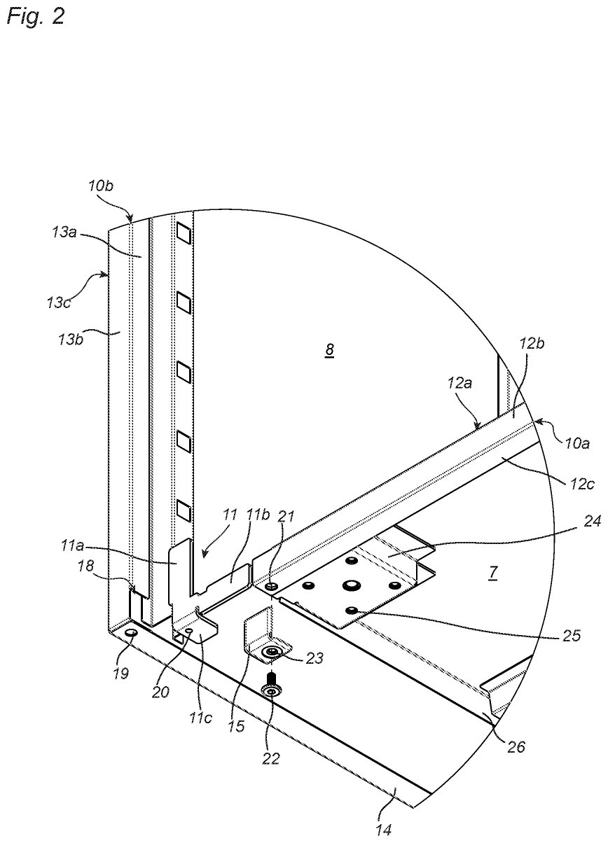

The lateral panels 8 are arranged perpendicular to the bottom panel 7, on the two lateral sides thereof, as seen from the front of the cabinet 1. For the interconnection of the bottom panel 7 and the lateral panel 8, reference is made to FIG. 2, showing one front bottom corner area from below. The front beam structure 10a, on the bottom panel 7, has been shaped by a bending of the sheet metal, such that a hollow metal channel with a C-section is formed at the front edge area of the bottom panel. The front beam structure 10a has three sides, a top side 12a, a front side 12b, and a bottom side 12c.

In the same manner, each of the front edges of the lateral panels 8 comprises a front beam structure 10b. In its turn, the front beam structure 10b has three sides: an inner side 13a, a front side 13b, and an outer side 13c. Also, each of the lateral panels 8 has a lower flange 14, which is utilized for the interconnection with a corresponding lateral edge of the bottom panel 7.

For a forming a stable connection of the front beam structures 10a, 10b of the bottom 7 and lateral 8 panels, respectively, a fitting in the form of a bottom reinforcement angle bar 11 is arranged in each bottom corner of the frame 4. As seen in FIG. 2, the bottom reinforcement angle bar 11 comprises three arms, 11a, 11b, and 11c, which each extends perpendicular to the other two arms. The two longer arms 11a, 11b are each arranged to extend, in a mounted position, inside of a respective one of the beam structures 10a, 10b, aligned against the insides of front sides 12b, 13b of the beam structures 10a, 10b.

The shorter arm 11c is arranged to extend along the inside of the lower flange 14 of the lateral side panel 8. The shorter arm 11c has a bore 20, which is to be aligned with corresponding bores 19, 21 arranged in the lower flange 14 and in the bottom side 12c of the beam structure 10a, respectively. In order to enable the alignment of the bores 19, 20, 21, there are cutouts 18 in the inner side 13a of the beam structure 10b and in the top side 12a of the beam structure 10a, respectively, in the corner region. Hereby the front beam structures 10a, 10b may form a stable and well-aligned corner of the frame 4. An outer bottom corner fitting 15 is arranged on the outside of the corner, and a screw 22 extends through the bores 19, 20, 21, as well as through a bore 23 in the bottom corner fitting 15 to secure the corner arrangement securely.

An attachment plate 24 is further arranged in the corner area, preferably by welding to the front beam structure 10a of the bottom panel 7. The castor wheels 5 or other support devices may be attached thereto, and the attachment plate 24 is provided with preformed bores 25 for this purpose.

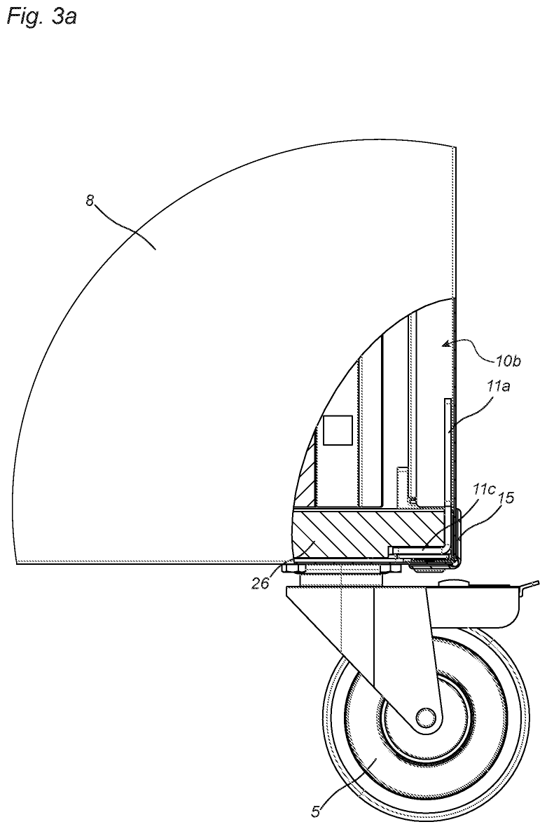

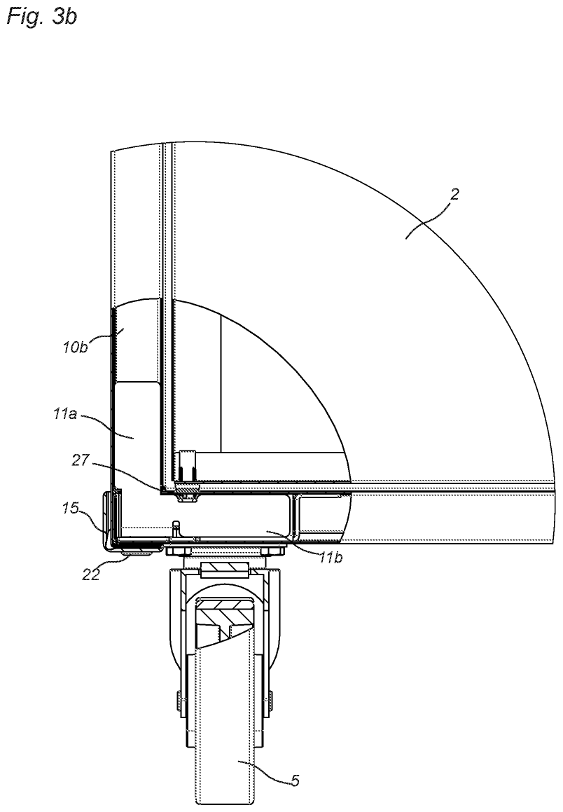

FIGS. 3a and 3b disclose the lower right corner area in the assembled position, as seen from the side and from the front. The longer arms 11a and 11b of the bottom reinforcement angle bar extend along the front of the frame 4, whereas the shorter arm 11c extend along the lower flange 14 of the bottom panel 8. The bottom reinforcement angle bar serves to orient the panels 7, 8 and the front frame 4 in relation to one another. The panels 7, 8 and the front frame 4 are kept in their positions relative to one another, while they are secured in these positions with one single screw 22 extending through the bores 19, 20, 21, and 23, of the beam structures 10a, 10b, the bottom corner fitting 15, and the bottom reinforcement angle bar 11. Further, the bottom reinforcement angle bar 11 is shaped with notches, to make room for a door pivot 27 and a screw for attachment of a castor wheel 5.

A corresponding, mirrored bottom reinforcement angle bar 11 is used in the opposite front bottom corner. In some embodiments bottom reinforcement angle bars 11 may be used alternatively as well as additionally in the back bottom corners of the cabinet 1, although this is not explicitly shown in the drawings.

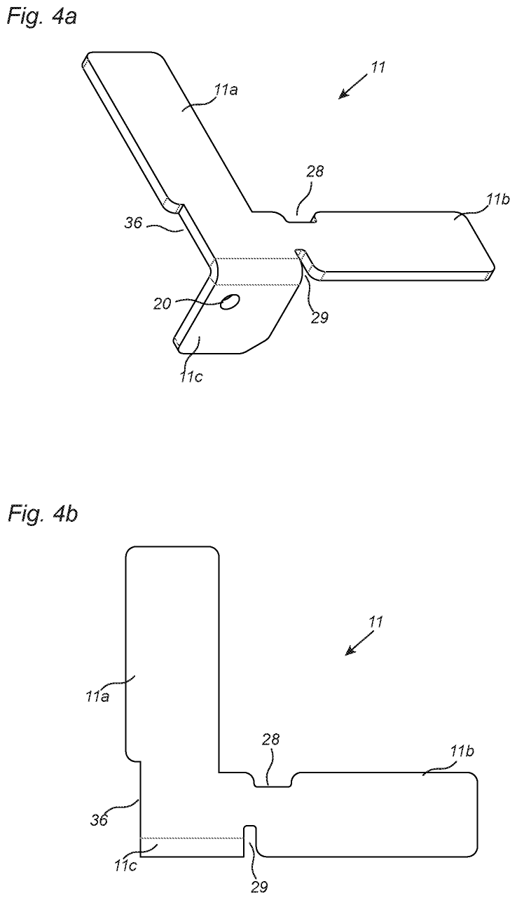

FIGS. 4a and 4b discloses one embodiment of the bottom reinforcement angle bar 11 before mounting in the cabinet 1. In particular, there is a notch 28 for a door pivot 27 in the arm 11b, which is intended to extend inside of the beam structure 10a at the front of the bottom panel 7. In the same arm 11b, there is also a notch 29 for the uptake of an attachment screw of a castor wheel 5. The outer contour of the bottom reinforcement angle bar 11 is adapted in the corner area 36, to accommodate the thickness of the sheet metal in the beam structure 10b. Another embodiment would be a mirrored version for use in an opposite corner of the cabinet 1.

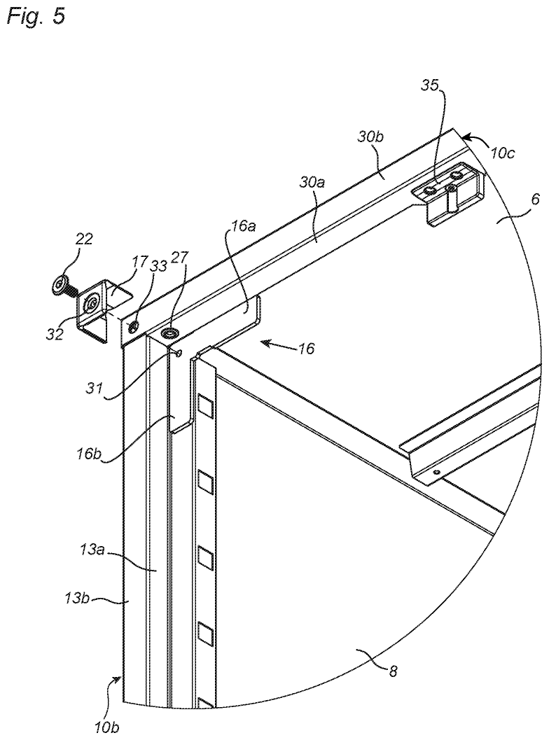

A left upper corner of the cabinet 1 is disclosed in FIG. 5 in a partially exploded view. A fitting in the form of a top reinforcement angle bar 16 is to be arranged with one arm 16b facing the inside of the front side 13b of the beam structure 10b of the lateral panel 8. The other arm 16a is to be aligned with the inside of the front side 30b of a beam structure 10c at the front of the top panel 6. This beam structure 10c is arranged and shaped in analogy with the beam structures 10 a and 10 b of the bottom and lateral panels 7, 8, i. e. by bending the sheet metal of the top panel 6 to form an integrated beam structure 10c While the arms 16a and 16b of the top reinforcement angle bar 16 keep the beam structures 10b and 10c in a fixed mutual position, an outer top corner fitting 17 is arranged from the exterior over the region where the beam structures 10b and 10c meet. A screw 34 extends from the outside through bores 31, 32, 33 in the top corner fitting 17, the beam structure 10c and the top reinforcement angle bar 16, respectively, thereby fixing the beam structures 10b, 10c and the top and lateral panels 6,8 in place. The opposite front corner of the cabinet 1 may be assembled in a corresponding manner. It may be noted that there is only one single version of the top reinforcement angle bar 16 since it is flat and hence reversible.

Also in FIG. 5, a stopper 35 may be seen mounted on a lower side 30a of the beam structure 10c on the top panel 6. The stopper 35 may keep the doors 2 from pivoting past it into the cabinet 1.

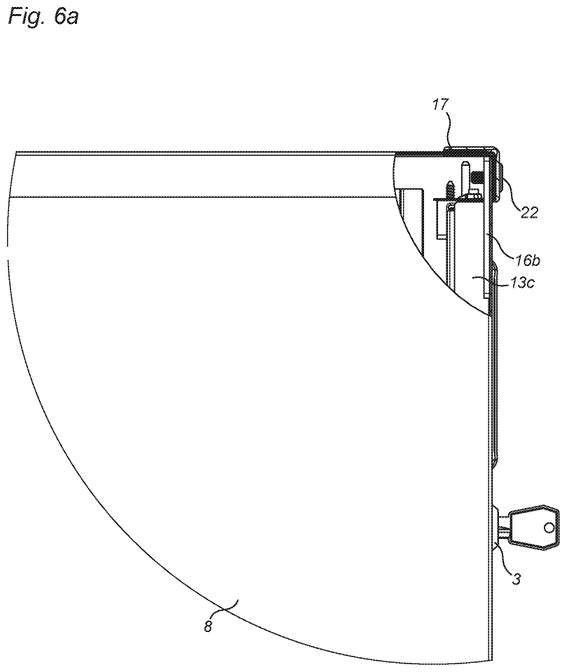

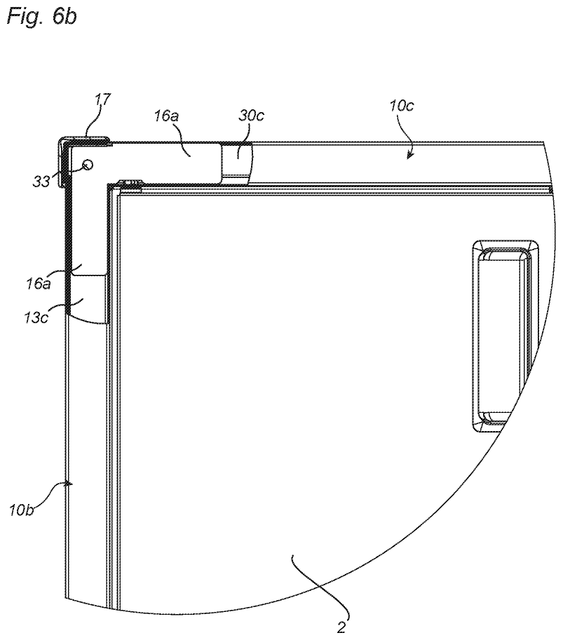

FIGS. 6a and 6b disclose the position of the top reinforcement angle bar 16 in its assembled position in the cabinet 1. Since the ends of the beam structures 10b, 10c meet, the sides 13a, 13b, 13c, 30a, 30b, 30c have to be provided with matching cutouts, similar to the cutouts 18 in the bottom corners discussed above. The outer contour of the top reinforcement angle bar 16 is adapted in the corner area 36, to accommodate the thickness of the sheet metal in the beam structure 10b.

As mentioned above regarding the bottom corners, the back top corners may utilize corresponding top reinforcement angle bars 16 as well.

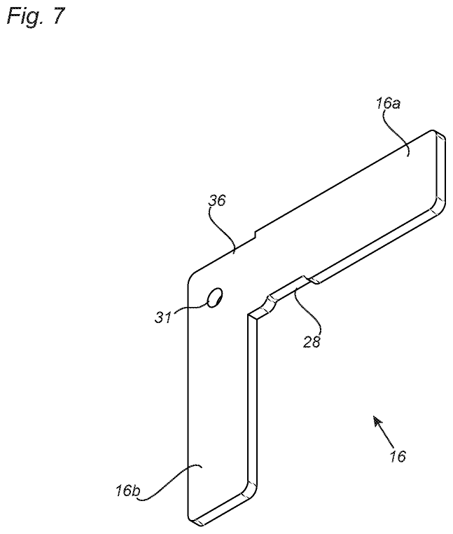

FIG. 7 discloses the top reinforcement angle bar 16 before it is mounted in the cabinet 1. The corner area 36 is clearly visible in this figure. This is the case also for a notch 28 for a pivot, corresponding to that of the bottom reinforcement angle bar 11.

The invention has mainly been described above with reference to a few embodiments. However, as is readily appreciated by a person skilled in the art, other embodiments than the ones disclosed above are equally possible within the scope of the invention, as defined by the appended patent claims.

In the claims, the word “comprising” does not exclude other elements or steps, and the indefinite article “a” or “an” does not exclude a plurality.

1. A fitting for mounting in a beam structure, the fitting comprising a sheet metal material, wherein the fitting further comprises a first and a second flat arm arranged to extend mutually perpendicularly in a single plane.

2. The fitting according to claim 1, wherein the first and second arms each has outer limitation lines, and a corner section of the fitting is defined by extensions of all the limitation lines, and a bore is arranged in the corner section.

3. The fitting according to claim wherein a third flat arm is arranged to extend perpendicularly to the plane of the first and second arms

4. The fitting according to claim 3, wherein a bore is arranged in the third flat arm.

5. A cabinet structure comprising a top panel a bottom panel, and two side panels, the panels, comprising sheet metal, wherein each of the panels, comprises at least one beam structure at an edge area of the panel the beam structure being formed by at least one bend in the sheet metal along an edge of the panel,.

6. The cabinet structure according to claim 5, wherein the beam structure is formed by two parallel bends along the edge of the panel.

7. The cabinet structure according to claim wherein at least two beam structures are joined at right angles.

8. The cabinet structure according to claim 7, wherein the beam structures include cutouts allowing a partial overlap at a joint between them.

9. The cabinet structure according to claim 7 comprising a fitting according to claim 1.

10. The cabinet structure according to claim 9, wherein the fitting is positioned to extend into at least two of the beam structures

11. The cabinet structure according to claim 10, wherein the arms of the fitting has a width slightly less than one side of the beam structures.

12. A cabinet comprising the cabinet structure according to claim a back panel, and a door.

13. The cabinet according to claim 12, wherein the cabinet further comprises a fitting according to claim 1.

14. The cabinet according to claim 12, wherein the door is pivotable on pivots arranged on at least one beam structure

15. The cabinet according to claim 12, any further comprising castor wheels.

16. (canceled)

17. A method for assembling the cabinet structure that includes a top panel, a bottom panel, and two side panels, the panels-comprising sheet metal, each of the panels comprising at least one beam structure at an edge area of the panel, the beam structure being formed by at least one bend in the sheet metal along an edge of the panel; the method comprising:
inserting two flat arms of a sheet metal fitting into different beam structure, the two flat arms arranged to extend mutually perpendicularly in a single plane;
aligning bores in the fitting with bores in the beam structures; and
securing the beam structures with a screw through the bores.
